(19) United States
(12) Patent Application Publication
(10) Pub. No.: US 2009/0155648 A1
(43) Pub. Date: Jun. 18, 2009

(54) Hydrogen storage system for fuel cell vehicle

(75) Inventors: Hoon Hee Lee, Seoul (KR); Hyung Ki Kim, Seoul (KR); Ki Ho Hwang, Gyeonggi-do (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 12/214,614

(22) Filed: Jun. 21, 2008

(30) Foreign Application Priority Data
Dec. 13, 2007 (KR) 10-2007-0129933

(51) Int. Cl. H01M 8/18

(52) U.S. Cl. 429/20

(57) ABSTRACT

The present invention provides a hydrogen storage system using a metal hydride (MH), which can increase volumetric storage density of hydrogen and total hydrogen storage capacity and improve system packaging.

For this purpose, the present invention provides a hydrogen storage system for a fuel cell vehicle, the hydrogen storage system including: an outer space filled with a first storage alloy powder that is able to release hydrogen at a high temperature; an inner space filled with a second storage alloy powder that is able to release hydrogen only with heat generated from a fuel cell stack; a metal filter disposed between the outer and inner spaces so as to divide the outer and inner spaces; a second heat exchange tube provided between the fuel cell stack and a radiator to constitute a cooling loop and arranged along a longitudinal direction of the inner space; and an independent heat exchange loop independently connected to the outer space for the hydrogen release of the first storage alloy powder.

### CROSS-REFERENCE TO RELATED APPLICATION

This application claims under 35 U.S.C. §119(a) the benefit of Korean Patent Application No. 10-2007-0129933 filed Dec. 13, 2007, the entire contents of which are incorporated herein by reference.

### BACKGROUND

(a) Technical Field

The present invention relates to a hydrogen storage system for a fuel cell vehicle. More particularly, the present invention relates to a hydrogen storage system using a metal hydride (MH), which can increase volumetric storage density of hydrogen and total hydrogen storage capacity and improve system packaging.

(b) Background Art

One of the essential requirements for commercializing fuel cell vehicles is to achieve a sufficient driving range, without refueling, corresponding to that of an internal combustion engine vehicle.

For example, in order to achieve a driving range of up to 300 miles on one fueling, a vehicle has to store hydrogen not less than about 5 kg.

At present, a high-pressure (35 MPa or 70 MPa) hydrogen storage system is used in fuel cell vehicles; however, it has a limitation in increasing the amount of hydrogen storage due to a low density of gaseous hydrogen.

That is, in order to store 5 Kg of hydrogen with a 35 MPa hydrogen storage system, a storage tank having an inner volume of about 215 L is required, which is inadequate for compact packaging of fuel storage system.

Moreover, in order to store 5 Kg of hydrogen with a 70 MPa hydrogen storage system, the required volume is about 125 L, which is considered more advantageous than the 35 MPa hydrogen storage system in terms of a vehicle package; however, it is disadvantageous in terms of system weight, price, and storage efficiency.

Recently, fuel cell vehicle developers have conducted extensive research aimed at developing new hydrogen storage systems, and various systems using liquid hydrogen, solid-phase hydrogen storage material, hydrogen generating material in a slurry phase, etc. have been proposed as an alternative for the high-pressure hydrogen storage system.

In case of a liquid hydrogen storage system, since the hydrogen liquefaction temperature is as low as −253° C., the energy used in the liquefaction consumes more than 30% of the energy of hydrogen, and thus the low energy efficiency should be overcome. Moreover, since the hydrogen is stored at an extremely low temperature, the hydrogen is evaporated continuously to increase the inner pressure of the storage tank and it is necessary to discharge the thus generated hydrogen gas (3% per day) to the outside of the storage tank.

In the case where the hydrogen generating material in a slurry phase is used in a hydrogen generating system, since the hydrogen is produced mainly by hydrolysis, by-products are formed after the generation of hydrogen and it is difficult to dispose of the by-products from the system mounted in a vehicle.

On the contrary, in the case where the hydrogen storage material in a solid-phase that can reversibly absorb (or adsorb) and release hydrogen is used, it is possible to complement the problems associated with the above systems, and thus it has been extensively studied recently.

Such a solid-phase storage material that can reversibly absorb (or adsorb) and release hydrogen includes a hydrogen storage alloy, a carbon based nanomaterial, a porous nanostructure, and the like.

In case of the nanomaterial and nanostructure, studies have not been much conducted; only a basic research as to whether it can store hydrogen reversibly has been conducted.

On the other hand, in case of the hydrogen storage alloy, there have been extensive research, to the extent that it is actually applied to Ni-MH batteries, and the possibility of the application to a hydrogen storage system for a vehicle has been investigated.

Since the hydrogen storage alloy absorbs (or adsorbs) hydrogen by reacting with hydrogen in a solid-phase, while it has a low weight storage density of 1.5 to 2.5 wt %, it has a very high volumetric storage density compared with the high-pressure hydrogen gas. Accordingly, it is very advantageous in terms of a package.

Moreover, since the hydrogen storage alloy can absorb/adsorb and release hydrogen at a lower pressure of about 10 MPa compared with the high-pressure (more than 35 MPa) system, it has an advantage that solves the problem of safety.

The hydrogen storage alloy includes various types of alloys such as AB5, AB2, BCC, etc. They have an advantage in that the hydrogen release temperature is very low to the extent that heat generated from the fuel cell can be used for hydrogen release; however, there is a limitation in that the weight storage density is as low as 1 to 2.5 wt % and thus the weight of the system increases.

Compared to this, hydrogen storage materials including an Mg-based MH or a complex metal hydride such as NaAlH₄, LiAlH₄, etc. have a high hydrogen storage density of 5 to 10 wt % or higher, compared with the conventional MH materials; however, the hydrogen release temperature is also as high as about 150 to 400° C., and thus waste heat of the fuel cell is not sufficient for hydrogen release.

Typical metals known in the art as the hydrogen storage alloys can store the hydrogen while producing an MH by an exothermic reaction with hydrogen under certain pressure and temperature conditions, and the MH can release the hydrogen by receiving appropriate heat.

During hydrogen absorption/adsorption, reaction of the storage alloy with hydrogen generates heat. The thus generated heat is necessary to be effectively removed to continue the reaction.

When an appropriate amount of heat is applied to the MH, the hydrogen is released and, at this time, the temperature of the MH is decreased. Accordingly, it is necessary to provide an appropriate amount of heat to the MH continuously and efficiently.

Like this, in order to apply the MH to the hydrogen storage system for the fuel cell vehicle, it is required to provide a structure that can ensure an efficient heat transfer. Accordingly, many researchers in the art have proposed techniques relating to a storage tank in which a heat exchanger is provided.

Examples of the techniques include a high pressure-MH hybrid hydrogen storage tank proposed by Toyota (FIG. 6), an MH hydrogen storage tank for a hydrogen internal combustion engine (FIG. 7) offered by Ovonics in U.S.A., and a compact MH hydrogen storage tank of Japan Steel Works (FIG. 8).

In general, the above conventional MH hydrogen storage tanks are applied to vehicles with a hydrogen charging/releasing system as shown in FIG. 5.

That is, a cooling loop including a coolant pump 500 and a radiator 400 for a fuel cell stack 300 is used to cool an MH hydrogen storage tank 100 during hydrogen charge and heat the same during hydrogen release.

The MH in the MH hydrogen storage tank 100 has a low hydrogen release temperature, and thus it can meet hydrogen supply conditions required by the fuel cell stack 300 only with waste heat generated from the fuel cell stack 300; however, since the weight storage density is low, the weight of the system becomes too heavy.

On the contrary, the storage materials including the Mg-based MH or the complex metal hydride such as NaAlH₄, LiAlH₄, etc. have a hydrogen storage density of 5 to 10 wt % or higher; however, since the hydrogen release temperature is as high as about 150 to 400° C., it is impossible to meet the hydrogen supply conditions required by the fuel cell stack only with the waste heat generated from the fuel cell.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. The present invention is directed to a hydrogen storage system for a fuel cell system, in which both a commercially available hydrogen storage alloy and a hydrogen storage material having a high hydrogen density and a low hydrogen release temperature are used, thus increasing the volumetric storage density and total hydrogen storage capacity and providing an advantageous structure for packaging the system.

In one aspect, the present invention provides a hydrogen storage system for a fuel cell system, the hydrogen storage system comprising: an outer space filled with a first storage alloy powder that is able to release hydrogen at high temperature; an inner space filled with a second storage alloy powder that is able to release hydrogen only with heat generated from a fuel cell stack; a metal filter disposed between the outer and inner spaces so as to divide the outer and inner spaces; a second heat exchange tube provided between the fuel cell stack and a radiator to constitute a cooling loop and arranged along a longitudinal direction of the inner space; and an independent heat exchange loop independently connected to the outer space for the hydrogen release of the first storage alloy powder.

In a preferred embodiment, the first storage alloy powder is one selected from the group consisting of Mg-based hydride, NaAlH₄, LiBH₄, LiAlH₄ and MgH₂ alloys.

In another preferred embodiment, the second storage alloy powder is one selected from the group consisting of BCC-based hydride, AB5, AB2, and BCC-based alloys.

In still another preferred embodiment, a plurality of heat transfer fins are integrally formed on an outer circumferential surface of the metal filter at regular intervals in a longitudinal direction thereof.

In yet another preferred embodiment, the first storage alloy powder is filled in a space between the outer circumferential surface of the metal filter and the heat transfer fins.

In still yet another preferred embodiment, the independent heat exchange loop comprises: at least one first heat exchange tubes arranged in the outer space along a longitudinal direction thereof; an inlet chamber connected to one end (inlet) of the first heat exchange tube or each of the first heat exchange tubes; an outlet chamber connected to the other end (outlet) of the first heat exchange tube or each of the first heat exchange tubes; heating means provided in the inlet chamber and heating a first heat transfer medium; a first heat transfer medium inlet line connected to the inlet chamber; a first heat transfer medium discharge line connected to the outlet chamber; and a pump and a reservoir for storing the first heat transfer medium disposed between the first heat transfer medium inlet line and the first heat transfer medium discharge line.

In a further preferred embodiment, temperature control means is connected to the heating means to control the temperature of the heating means based on information from a temperature sensor provided in the inlet chamber so as to maintain the temperature of the first storage alloy powder constant.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a cross-sectional view showing a main part of a hydrogen storage tank of a hydrogen storage system for a fuel cell vehicle in accordance with a preferred embodiment of the present invention;

FIG. 2 is a perspective view showing the inside of the hydrogen storage tank of a hydrogen storage system for a fuel cell vehicle in accordance with the preferred embodiment of the present invention;

FIG. 3 is a perspective view showing the outside of the hydrogen storage tank of a hydrogen storage system for a fuel cell vehicle in accordance with the preferred embodiment of the present invention;

FIG. 4 is a schematic view illustrating the hydrogen storage system for a fuel cell vehicle in accordance with the present invention;

FIG. 5 is a schematic view illustrating a conventional hydrogen storage system for a fuel cell vehicle; and

FIGS. 6 to 8 are schematic views showing the structures of conventional hydrogen storage tanks for fuel cell vehicles.

Reference numerals set forth in the Drawings includes reference to the following elements as further discussed below:

| | |
|---|---|
| 10: first storage alloy powder | 12: second storage alloy powder |
| 14: metal filter | 16: first heat exchange tube |
| 18: second heat exchange tube | 20: heat transfer fin |
| 22: inlet chamber | 24: outlet chamber |
| 26: heating means | 28: temperature control means |
| 30: temperature sensor | 32: heat transfer medium inlet line |
| 34: heat transfer medium discharge | |
| line | |
| 36: pump | 38: reservoir |
| 40: hydrogen gas outlet | 100: hydrogen storage tank |
| 200: independent heat exchange loop | |
| 300: fuel cell stack | 400: radiator |
| 500: coolant pump | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

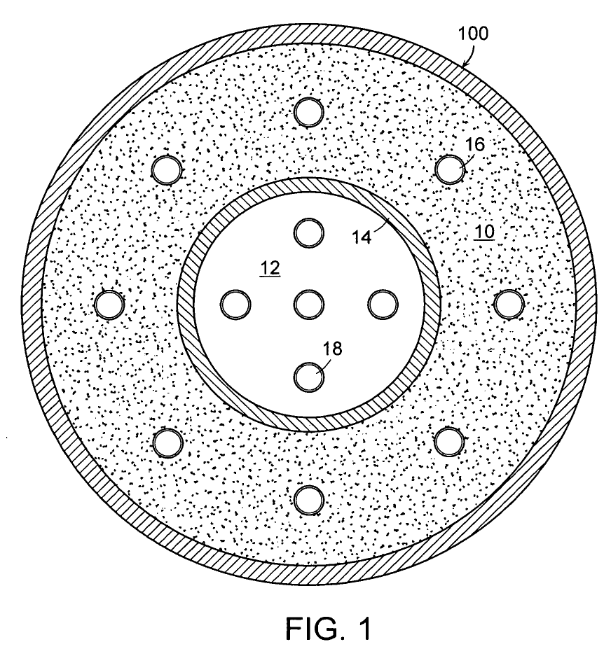

FIG. 1 is a cross-sectional view showing a main part of a hydrogen storage tank of a hydrogen storage system for a fuel cell vehicle in accordance with a preferred embodiment of the present invention.

As show in FIG. 1, a first storage alloy powder 10, which can release hydrogen at a relatively high temperature, is filled in an outer space V1 of an MH hydrogen storage tank 100 in a cylindrical shape, and a second storage alloy powder 12, which can release hydrogen only with heat generated from a fuel cell stack 300, i.e., which can release hydrogen at a low temperature, is filled in an inner space V2 thereof.

In particular, the first storage alloy powder 10 is filled outside of a metal filter 14 and the second storage alloy powder 12 is filled inside of the metal filter 14. The reason for the use of the metal filter 14 is to enable the hydrogen to pass through the outer and inner spaces V1 and V2 and to prevent the metal powders from passing therethrough.

The outer space V1 of the MH hydrogen storage tank 100 is connected to an independent heat exchange loop 200. The independent heat exchange loop 200 includes at least one first heat exchange tubes 16 which pass through the first storage alloy powder 10, a high-temperature storing material. It operates independently from a cooling loop of the fuel cell stack 300.

Moreover, a plurality of second heat exchange tubes 18, the cooling loop coming from the fuel cell stack 300, pass through the second storage powder 12 in the inner space V2 of the MH hydrogen storage tank 100.

For example, an Mg-based hydride having a hydrogen storage capacity of 7 wt % and a hydrogen release temperature of about 300° C. is filled in the outer space V1 of the MH hydrogen storage tank 100, and a BCC-based hydride having a hydrogen storage capacity of 2 wt % and capable of releasing the hydrogen at room temperature is filled in the inner space V2 of the MH hydrogen storage tank 100.

Preferably, for example, AB5, AB2 and BCC-based alloys having a hydrogen release temperature lower than the operation temperature of the fuel cell stack 300 may be filled in the inner space V2 of the MH hydrogen storage tank 100. Alloys such as NaAlH₄, LiBH₄, LiAlH₄, MgH₂, Mg(BH)₂, and NH₂BH₂ having a hydrogen release temperature higher than the operation temperature of the fuel cell stack 300 may be filled in the outer space V1. Also preferably, any combination of the above alloys may be used.

In the structure of the above-described MH hydrogen storage tank 100, when assuming that the first radius R1 from the midpoint of the tank to the outermost portion of the outer space V1 is 20 cm, the second radius R2 from the midpoint of the tank to the outermost portion of the inner space V2 is 10 cm, and the length L of the cylinder is 90 cm, the volumes of the outer space V1 and the inner space V2 of the MH hydrogen storage tank 100 are 85 L and 28 L, respectively, and the total volume of the tank is 113 L.

That is, 80 L of Mg-based hydride may be filled in the outer space V1 of the MH hydrogen storage tank 100, excluding the volume (about 5 L) of the inner heat exchanger, i.e., the first heat exchange tubes 16, and 25 L of BCC-based hydride may be filled in the inner space V2, excluding the volume (about 3 L) of the inner heat exchanger, i.e., the second heat exchange tubes 18.

In this case, 96 Kg of Mg-based alloy with a powder density of about 1.2 g/cc and 90 Kg of BCC-based alloy with a powder density of about 3.6 g/cc may be filled in 15 the outer space V1 and the inner space V2, respectively. The hydrogen storage capacity of the Mg-based alloy may be 6.7 kg, the BCC-based alloy may be 1.8 Kg, and the total hydrogen storage capacity may be 8.5 Kg.

As such, with the simultaneous use of the Mg-based hydride, which is a hydrogen storage alloy having a high hydrogen release temperature and filled in the outer space V1 of the MH hydrogen storage tank 100, and the BCC-based hydride, which is a hydrogen storage alloy filled in the inner space V2 of the MH hydrogen storage tank 100 to release hydrogen at low temperature (room temperature), it is possible to satisfy a target driving range without refueling of the fuel cell vehicle, even though there is an increase in the weight of the system (about 250 Kg).

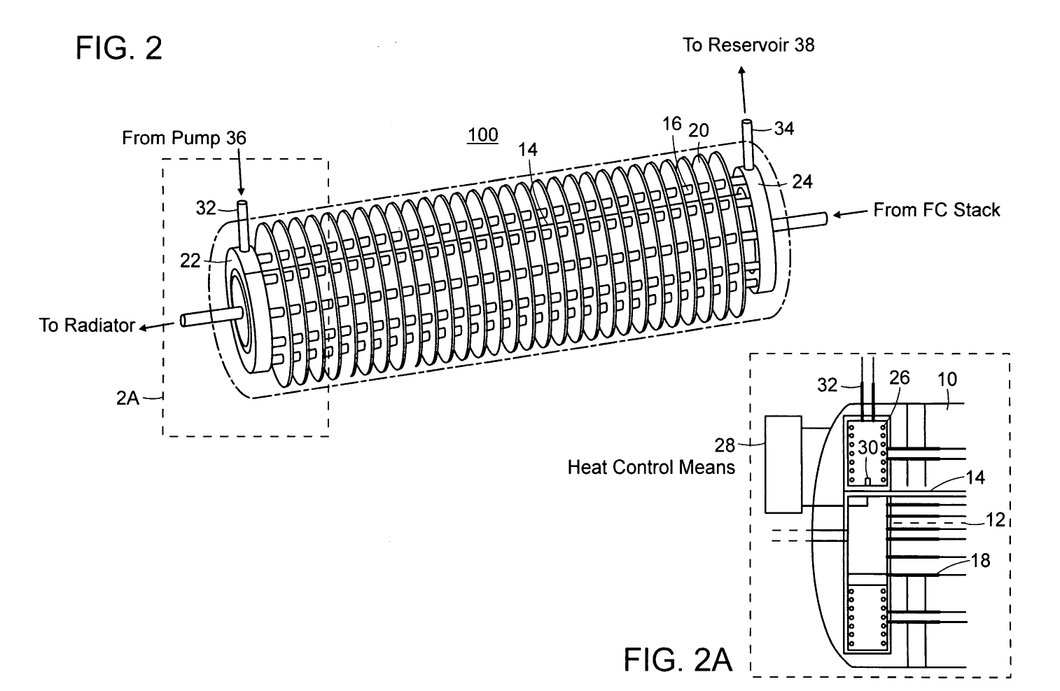

Next, the structure and the operation of the MH hydrogen storage tank in accordance with the present invention will be described in more detail with reference to FIGS. 2 to 4.

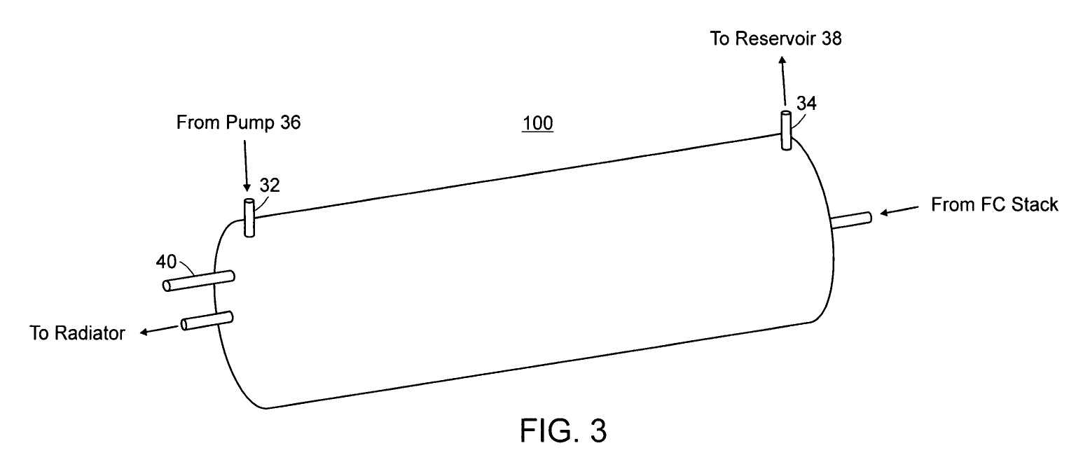

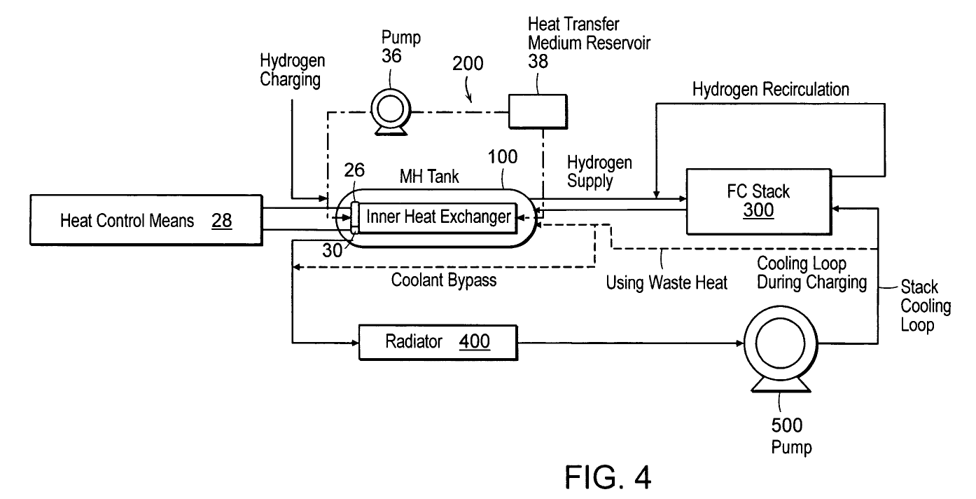

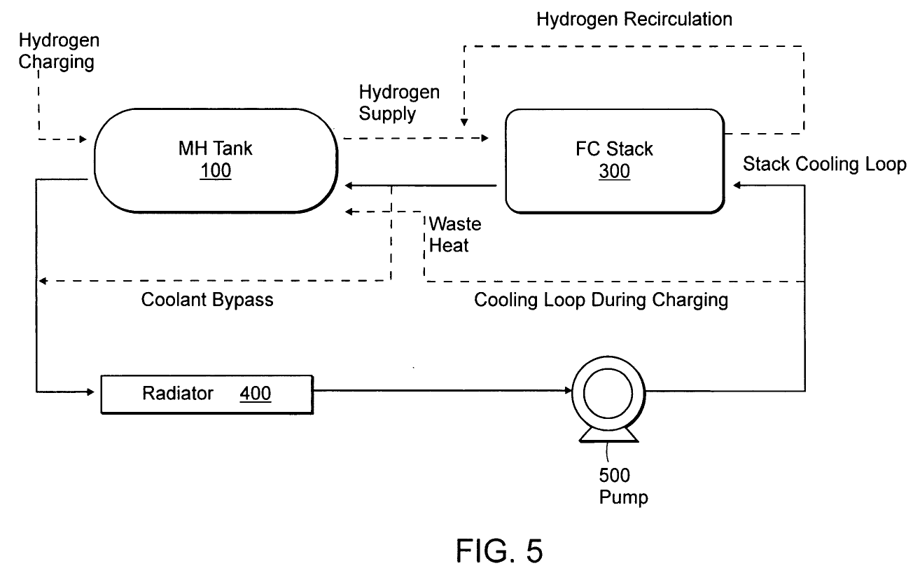

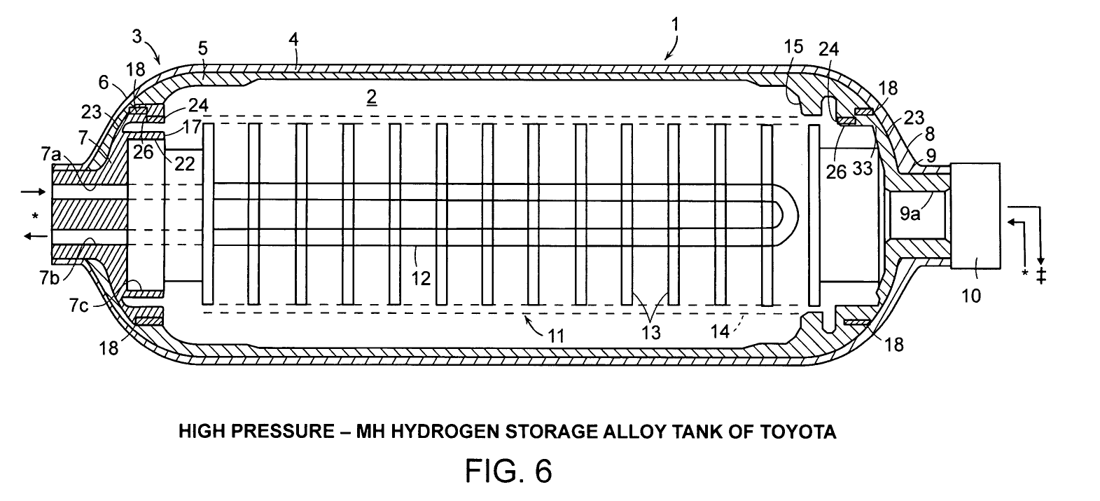

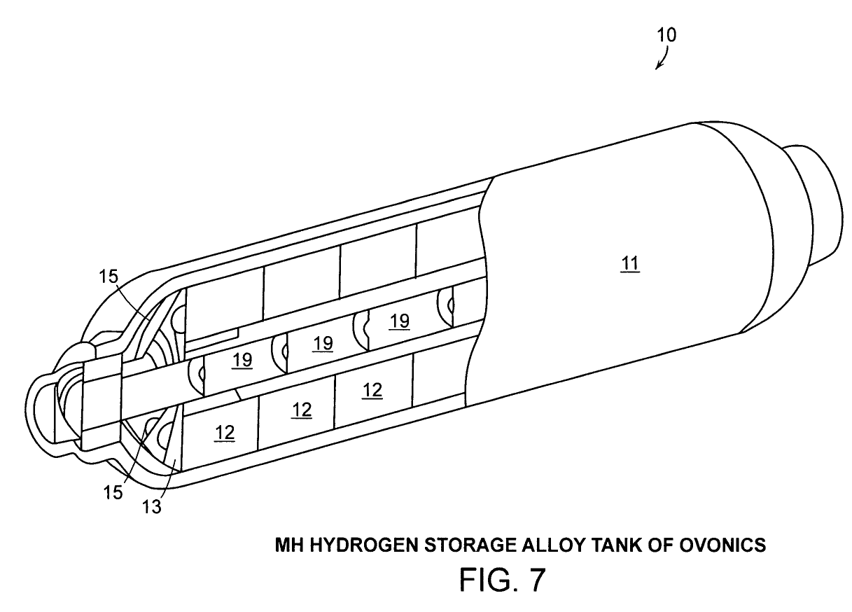

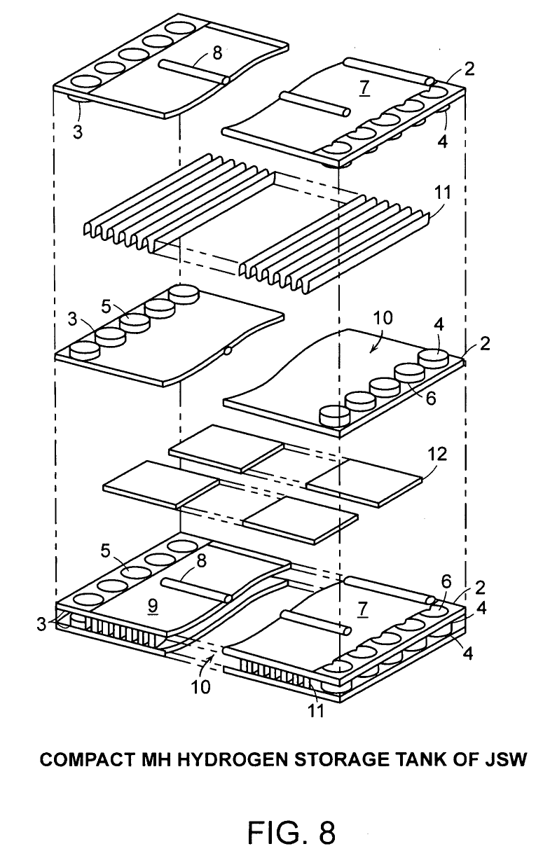

FIGS. 2 and 3 are perspective views showing the inside and the outside of the hydrogen storage tank of a hydrogen storage system for a fuel cell vehicle, respectively, and FIG. 4 is a schematic view illustrating the hydrogen storage system for a fuel cell vehicle.

First, the structure of the inner space of the MH hydrogen storage tank in accordance with the present invention and the hydrogen storage flow by the heat transfer operation will be described below.

The inner space V2 of the MH hydrogen storage tank 100 has a cylindrical shape and is directed to the internal space of the metal filter 14. The second storage alloy powder 12, which can release hydrogen only with the heat generated from the fuel cell stack 300, is filled therein. A plurality of second heat exchange tubes 18 are arranged to pass through the second storage alloy powder 12.

The second heat exchange tubes 18 constitute the cooling loop of the fuel cell stack 300. One end (inlet) of each of the second heat exchange tubes 18 is connected to an outlet portion of the fuel cell stack 300, and the other end is connected to a radiator 400.

Accordingly, when a second heat transfer medium (coolant) supplied after cooling the fuel cell stack 300 flows in the second heat exchange tubes 18, the second heat transfer medium exchanges heat with the second storage alloy powder 12 filled in the inner space V2.

As a result, the second storage alloy powder 12, i.e., the BCC-based hydride, filled in the inner space V2, acts to release hydrogen only with the heat generated from the fuel cell stack 300.

That is, as the cooling loop of the fuel cell stack 300, the radiator 400 serving to remove the heat generated during the operation of the fuel cell is connected to a coolant pump 500 serving to facilitate the circulation of the coolant for the cooling loop with the second heat exchange tubes 18 interposed therebetween. Accordingly, when the hydrogen is charged in the MH hydrogen storage tank 100, the coolant is circulated through the cooling loop that does not pass through the fuel cell stack 300 to cool the MH hydrogen storage tank 100, whereas, when the fuel cell stack 300 is operated, the coolant in the fuel cell stack 300 is introduced into the second heat exchange tubes 18 so that the second heat exchange tubes 18 release the hydrogen only with the heat generated from the fuel cell stack 300.

Next, the structure of the outer space of the MH hydrogen storage tank in accordance with the present invention and the hydrogen storage flow by the heat transfer operation will be described below.

The outer space V1 is defined by the outer circumferential surface of the metal filter 14 and the inner circumferential surface of the MH hydrogen storage tank 100. The first storage alloy powder 10 capable of releasing the hydrogen at high temperature is filled in the outer space V1, and a plurality of first heat exchange tubes 16 are arranged to pass through the first storage alloy powder 10.

In this case, as shown in FIG. 2, a plurality of heat transfer fins 20 in the form of a circular plate are integrally formed on the outer circumferential surface of the metal filter 14 at regular intervals in the longitudinal direction thereof. Substantially, the first storage alloy powder 10 is filled between the heat transfer fins 20, and the first heat exchange tubes 16 are disposed to penetrate the heat transfer fins 20.

Moreover, an inlet chamber 22 and an outlet chamber 24 are mounted on the outer circumferential surfaces of both ends of the metal filter 14.

Accordingly, one end (inlet) of each of the first heat exchange tubes 16 is connected to the inlet chamber 22 and the other end (outlet) thereof is connected to the outlet chamber 24.

Especially, heating means 26 for heating a first heat transfer medium is provided in the inlet chamber 22, and temperature control means 28 is connected to the heating means 26 to control the temperature of the heating means 26.

In particular, the temperature control means 28 controls the temperature of the heating means 26 based on information from a temperature sensor 30 provided in the inlet chamber 22 so as to maintain the temperature of the first storage alloy powder 10 constant.

Moreover, a heat transfer medium inlet line 32 is connected to the inlet chamber 22, and a heat transfer medium discharge line 34 is connected to the outlet chamber 24.

Furthermore, a pump 36 and a reservoir 38 for storing the heat transfer medium are disposed between the heat transfer medium inlet line 32 and the heat transfer medium discharge line 34. The reservoir 38 stores the heat transfer fluid and also serves as a radiator for cooling the heat transfer medium during hydrogen charge.

Accordingly, with the operation of the pump 36, the first heat transfer medium stored in the reservoir 38 circulates in the order of the heat transfer medium inlet line→inlet chamber→first heat exchange tubes→outlet chamber→heat transfer medium discharge line→reservoir. During the circulation, the first heat transfer medium in the inlet chamber 22 is heated by the heating means 26.

In this case, since the overall reservoir 38 for storing the heat transfer medium is not heated, rather, the heating means 26 is provided inside the inlet chamber 22 through which the first heat transfer medium flows, it is possible to perform the heat transfer to the first storage alloy powder 10 with less energy compared with the case where the heating means is provided in the overall hydrogen storage tank.

Accordingly, when the first heat transfer medium heated by the heating means 26 flows from the inlet chamber 22 to the first heat exchange tubes 16, the first storage alloy powder 10 is heated and, at the same time, the first storage alloy powder 10 is further heated by the heat transferred to the heat transfer fins 20 such that the hydrogen is released from the first storage alloy powder 10, i.e., the Mg-based hydride, filled in the outer space V1 of the MH hydrogen storage tank 100 and having a high hydrogen release temperature.

Like this, since the first storage alloy powder 10 that releases the hydrogen at high temperature cannot release the hydrogen only with the heat generated from the fuel cell stack 300, the independent heat exchange loop 200 including the additional heating means 26, the reservoir 38 for controlling the same, the pump 36, and the temperature control means 28 is provided to facilitate the hydrogen release operation of the first storage alloy powder 10.

Meanwhile, as shown in FIG. 3, a hydrogen gas outlet 40 is provided on one side of the hermetically prepared MH hydrogen storage tank 100 to draw the hydrogen produced from the first and second storage alloy powders 10 and 12.

As described above, the present invention provides effects including the following: It is possible to increase the hydrogen storage capacity of the hydrogen storage system for the fuel cell vehicle by utilizing the hydrogen storage alloy, which may not be applied to the hydrogen storage tank for the fuel cell vehicle, since the hydrogen release temperature is high, although the hydrogen storage density is high, i.e., the hydrogen storage alloy that releases the hydrogen at high temperature, together with the hydrogen storage alloy powder capable of releasing the hydrogen only with the generated from the fuel cell stack. Moreover, although the weight of the system may be increased with the use of the hydrogen storage alloy capable of releasing the hydrogen at high temperature, the increase in the weight of the system is not serious, and it is possible to satisfy a target driving range on a single charge of the fuel cell vehicle, even though there is an increase in the weight of the system.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A hydrogen storage system for a fuel cell vehicle, the hydrogen storage system comprising:
an outer space filled with a first storage alloy powder that is able to release hydrogen at high temperature;
an inner space filled with a second storage alloy powder that is able to release hydrogen only with heat generated from a fuel cell stack;
a metal filter disposed between the outer and inner spaces so as to divide the outer and inner spaces;
a second heat exchange tube provided between the fuel cell stack and a radiator to constitute a cooling loop and arranged along a longitudinal direction of the inner space; and
an independent heat exchange loop independently connected to the outer space for the hydrogen release of the first storage alloy powder.

2. The hydrogen storage system of claim 1, wherein the first storage alloy powder is one selected from the group consisting of Mg-based hydride, NaAlH₄, LiBH₄, LiAlH₄ and MgH₂ alloys.

3. The hydrogen storage system of claim 1, wherein the second storage alloy powder is one selected from the group consisting of BCC-based hydride, AB5, AB2, and BCC-based alloys.

4. The hydrogen storage system of claim 1, wherein a plurality of heat transfer fins are integrally formed on an outer circumferential surface of the metal filter at regular intervals in alongitudinal direction thereof.

5. The hydrogen storage system of claim 1, wherein the first storage alloy powder is filled in a space between the outer circumferential surface of the metal filter and the heat transfer fins.

6. The hydrogen storage system of claim 1, wherein the independent heat exchange loop comprises:
at least one first heat exchange tubes arranged in the outer space along a longitudinal direction thereof;
an inlet chamber connected to one end (inlet) of the first heat exchange tube or each of the first heat exchange tubes;
an outlet chamber connected to the other end (outlet) of the first heat exchange tube or each of the first heat exchange tubes;
heating means provided in the inlet chamber for heating a first heat transfer medium;
a first heat transfer medium inlet line connected to the inlet chamber;
a first heat transfer medium discharge line connected to the outlet chamber; and
a pump and a reservoir for storing the first heat transfer medium disposed between the first heat transfer medium inlet line and the first heat transfer medium discharge line.

7. The hydrogen storage system of claim 6, wherein temperature control means is connected to the heating means to control the temperature of the heating means based on information from a temperature sensor provided in the inlet chamber so as to maintain a constant temperature of the first storage alloy powder.
